(19) United States
(12) Patent Application Publication
(10) Pub. No.: US 2013/0125777 A1
(43) Pub. Date: May 23, 2013

(54) TRUCK-TYPE CONVEYANCE SYSTEM

(71) Applicants: Satoshi Yamaguchi, Miyoshi-shi (JP); Shinji Toyoma, Toyota-shi (JP); Yasuhiro Okamoto, Toyota-shi (JP); Ngoshi Richard Alinine, Seto-shi (JP)

(72) Inventors: Satoshi Yamaguchi, Miyoshi-shi (JP); Shinji Toyoma, Toyota-shi (JP); Yasuhiro Okamoto, Toyota-shi (JP); Ngoshi Richard Alinine, Seto-shi (JP)

(73) Assignee: Toyota Jidosha Kabushiki Kaisha, Toyota-shi (JP)

(21) Appl. No.: 13/813,053

(22) PCT Filed: Jul. 26, 2011
(86) PCT No.: PCT/IB11/02137

§ 371 Date: Jan. 29, 2013

(30) Foreign Application Priority Data
Jul. 30, 2010 (JP) 2010-172897

(51) Int. Cl. B61B 13/04; B65G 19/02

(52) U.S. Cl. CPC B61B 13/04; B65G 19/02
USPC 104/119

(57) ABSTRACT

A truck-type conveyance system includes a propelled portion which is propelled with frictional force, a truck which is coupled with the propelled portion, guides that are a plurality of guide members defining a propulsive direction of the propelled portion and forming a propulsion path, and a drive unit which provides frictional force in the propulsive direction to the propelled portion. The propelled portion is formed with a driven member which is an elastic member elastically deforming along a curvature of the propulsion path.

### BACKGROUND OF THE INVENTION

1. Field of the Invention

The present invention relates to a technology of a truck-type conveyance system for propelling a truck for conveying workpieces along a prescribed path by a friction drive means.

2. Description of the Related Art

Conventionally, there has been known a truck-type conveyance system in which a plurality of trucks for conveying workpieces are propelled along a prescribed path by a friction drive means in a manner such that the trucks push each other in a chain reaction manner. Such a truck-type conveyance system can successfully propel each truck in linear paths and has a work step for each kind of assembly work and so forth along such linear paths.

However, the conventional truck-type conveyance system has difficulty in propulsion of each truck by allowing them to push each other in the chain reaction manner in curved paths having a U-shaped returning portion or the like. Accordingly, in a transition from a linear travel path to the curved path having a U-shaped returning portion or the like, a conveyance means such as an AGV or a traverser has to be used. There is difficulty in placing the work step for each kind of assembly work along the curved paths.

Accordingly, there are various technological attempts relating to truck-type conveyance systems to successfully propel each truck along a curved path. For example, such a technology is disclosed in Japanese Patent Application Publication No. 2002-240707 (JP-A-2002-240707). JP-A-2002-240707 discloses a truck-type conveyance system including a driving friction surface formed with a side surface of a rod-shaped body attached in parallel with a travel direction at a central portion in a left-right width direction below a bed of a truck. In the system, a front rod-shaped body and a rear rod-shaped body that do not protrude from both front and rear ends of the bed are horizontally left-right slidably coupled with both front and rear ends of the rod-shaped body. These rod-shaped bodies form the bendable driving friction surface reaching a substantially entire length of the bed. Such a configuration allows the rod-shaped bodies to bend along a curved path and enables travel of the truck on such a curved path. As a result, the truck-type conveyance system does not require a device such as a traverser for changing the direction of the truck, which would be conventionally required.

However, the truck-type conveyance system' disclosed in JP-A-2002-240707 has difficulty in travelling on a curved path with a smaller radius of curvature. Therefore, a development of a truck-type conveyance system which can flexibly adapt oneself to various work step arrangements has been desired. Further, since such a conventional truck-type conveyance system secures a place in which a drive unit for providing driving force to driven portions is placed within a workspace, there is a problem that the available work space for work steps and so forth are reduced.

### SUMMARY OF THE INVENTION

The present invention provides a truck-type conveyance system which is capable of enabling travel of a truck along a curved path of, more flexibly adapting to various work step arrangements, and of more effectively using a work space.

A first aspect of the present invention provides a truck-type conveyance system including: a propelled portion which is propelled with frictional force; a truck which is coupled with the propelled portion; a plurality of guide members which define a propulsive direction of the propelled portion and form a propulsion path; and a drive unit which provides frictional force in the propulsive direction to the propelled portion, in which the truck travels along the propulsion path with frictional force provided to the propelled portion as its propulsive force. In the truck-type conveyance system, a section of the propelled portion to which the frictional force is provided is formed with an elastic member which is a member elastically deforming along the propulsion path.

According to this aspect, even if a travel path of the truck is curved, the truck can travel along the travel path without use of a separate conveyance system.

The elastic member may be a belt-like member. This allows easy deformation of the propelled portion along the propulsion path.

The elastic member may be formed with a steel plate. This allows easy deformation of the propelled portion along the propulsion path and easy recovery of the deformed propelled portion to a plate shape.

The drive unit may be placed below a travel surface on which the truck travels. This allows more effective use of a workspace.

A groove which is passed through the travel surface of the truck is formed along the propulsion path. A support portion which protrudes from the elastic member is arranged on a truck-placement side from the groove across the travel surface of the truck. A locking member is disposed on the support portion. The truck is locked by the locking member. The elastic member and the truck may be thereby coupled together. Accordingly, even if a travel path of the truck is curved, the truck can travel along the travel path with a simple configuration and without use of a separate conveyance system.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a perspective schematic diagram showing a truck-type conveyance system in accordance with an embodiment of the present invention;

FIG. 2 is a partially cross-sectional schematic diagram showing the truck-type conveyance system in accordance with an embodiment of the present invention;

FIG. 3 is a plan schematic diagram showing an arrangement of guides in the truck-type conveyance system in accordance with an embodiment of the present invention;

FIG. 4 is a plan schematic diagram showing a drive unit of the truck-type conveyance system in accordance with an embodiment of the present invention;

FIG. 5 is a perspective schematic diagram showing a work floor in the truck-type conveyance system in accordance with an embodiment of the present invention;

FIG. 6 are schematic diagrams showing a propelled portion of the truck-type conveyance system in accordance with an embodiment of the present invention, in which

FIG. 6A is a plan schematic diagram and FIG. 6B is a side schematic diagram;

FIG. 7 are partial schematic diagrams of coupling portions of the propelled portion of the truck-type conveyance system in accordance with an embodiment of the present invention, in which FIG. 7A is a schematic diagram showing a state before coupling, FIG. 7B is a schematic diagram showing a coupled state, and FIG. 7C is a schematic diagram showing a decoupled state;

FIG. 8 is a plan schematic diagram showing a truck of the truck-type conveyance system in accordance with an embodiment of the present invention;

FIG. 9 are schematic diagrams showing propelling conditions of the propelled portion in the truck-type conveyance system in accordance with an embodiment of the present invention, in which FIG. 9A is a plan schematic diagram, FIG. 9B is a cross-sectional schematic diagram taken along line A-A, and FIG. 9A is a cross-sectional schematic diagram taken along line B-B; and

FIG. 10 is a plan schematic diagram showing a setting example of a propulsion path in the truck-type conveyance system in accordance with an embodiment of the present invention.

### DETAILED DESCRIPTION OF THE PREFERRED EMBODIMENTS

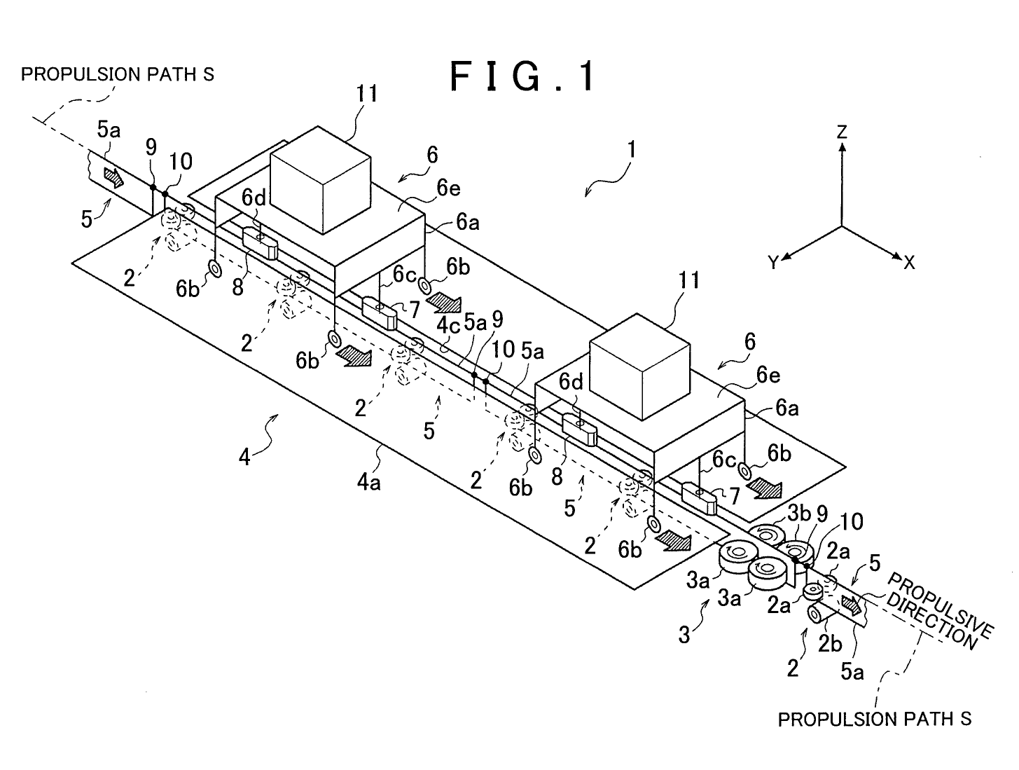

An embodiment of the present invention will be described hereinafter. A general configuration of a truck-type conveyance system in accordance with an embodiment of the present invention will be described with reference to FIGS. 1 to 8. In the following descriptions, as shown in FIG. 1, the propulsive direction of a propelled portion is provided as an X-axis direction and will be referred to as “front.” A Y-axis direction will be referred to as “right,” and a Z-axis direction will be referred to as “up.” As shown in FIG. 1, a truck-type conveyance system 1 which is the truck-type conveyance system in accordance with an embodiment of the present invention is configured with a plurality of guides 2, a drive unit 3, a work floor 4, a plurality of propelled portions 5, a plurality of trucks 6, and so forth. The truck-type conveyance system 1 has a working space for workers that is formed by the work floor 4 on which the plurality of trucks 6 travels. The trucks 6 having workpieces 11 placed thereon travel to serially pass through work steps with respective work pieces 11 placed on the trucks. Accordingly, assembly line work is efficiently carried out by workers waiting at the work area.

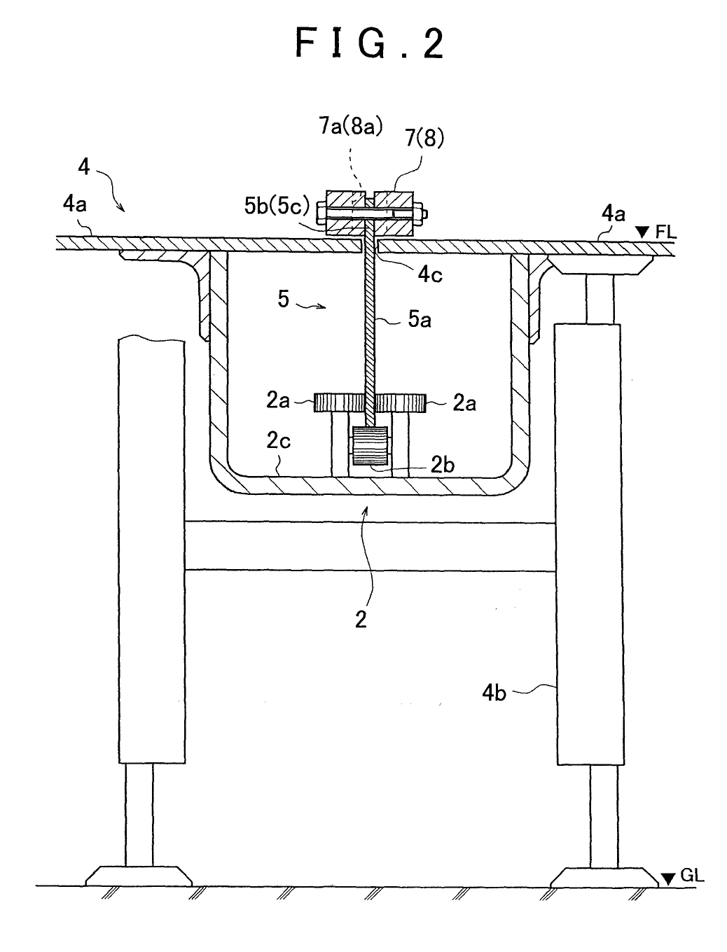

As shown in FIGS. 1 and 2, the guides 2 define the positions of the propelled portions 5 and guide the propelled portions 5 in the propulsive direction. As shown in FIG. 2, the guide 2 has horizontal guide rollers 2a formed with a pair of driven rollers that keep their axial direction vertical and a vertical guide roller 2b formed with a single driven roller that keeps its axial direction horizontal. Each of the rollers 2a, 2b is rotatably journaled with respect to a frame portion 2c fixed to the work floor 4.

The horizontal guide rollers 2a are a pair of roller members that keep their axial directions vertical and are journaled in parallel with each other. The separation distance between the peripheral surfaces of the rollers 2a (i.e., gap) is kept at a prescribed width. The prescribed width corresponds to, the thickness of a driven member 5a that forms the propelled portion 5 and is set to allow the driven member 5a to pass through the gap formed by the rollers 2a and to allow the front and back surfaces of the driven member 5a to contact with the rollers 2a, 2a. Further, in this embodiment, a case is illustrated that the gap is provided between the rollers 2a. However, it is possible that each of the rollers 2a is formed with an elastic member, the rollers 2a contact with each other (in other words, the gap is not formed), the rollers 2a are allowed to elastically deform, and the driven member 5a thereby passes through between the rollers 2a.

The propelled portion 5 passes through the gap formed between the rollers 2a, and the rollers 2a are brought into contact with the front and back surfaces of the driven member 5a. Accordingly, the position of the driven member 5a is controlled with respect to the horizontal direction (the thickness direction of the driven member 5a), thereby guiding the propelled portion 5 in a desired propulsive direction. More specifically, the horizontal guide rollers 2a guide the propelled portion 5 in the propulsive direction that is the direction being horizontally perpendicular to the shortest segment between the axes of the horizontal guide rollers 2a and passing through the midpoint of the shortest segment.

The vertical guide roller 2b is a single roller member journaled with its axial direction kept horizontal. A separate distance between an upper peripheral surface of the vertical guide roller 2b and a floor surface formed by the work floor 4 (position FL in FIG. 2) is kept at a prescribed distance. The prescribed distance corresponds to the dimension in the height direction of the driven member 5a of the propelled portion 5, and is set to the distance at which in the case that the driven member 5a is placed with its lower surface contacting with the roller 2b, an upper surface (support portions 5b, 5c which will be described later) of the driven member 5a protrudes above the floor surface of the work floor 4 in the vertical direction. In a plan view, the propelling direction set in the horizontal rollers 2a is perpendicular to the axial direction of the vertical guide roller 2b. The rotational direction of the vertical guide roller 2b is along the propulsive direction set in the horizontal guide rollers 2a.

The propelled portion 5 is propelled with the lower surface of the driven member 5a contacting with the vertical guide roller 2b, thereby controlling the position of the driven member 5a with respect to the height direction. Accordingly, the propelled portion 5 is guided in a desired propelling direction.

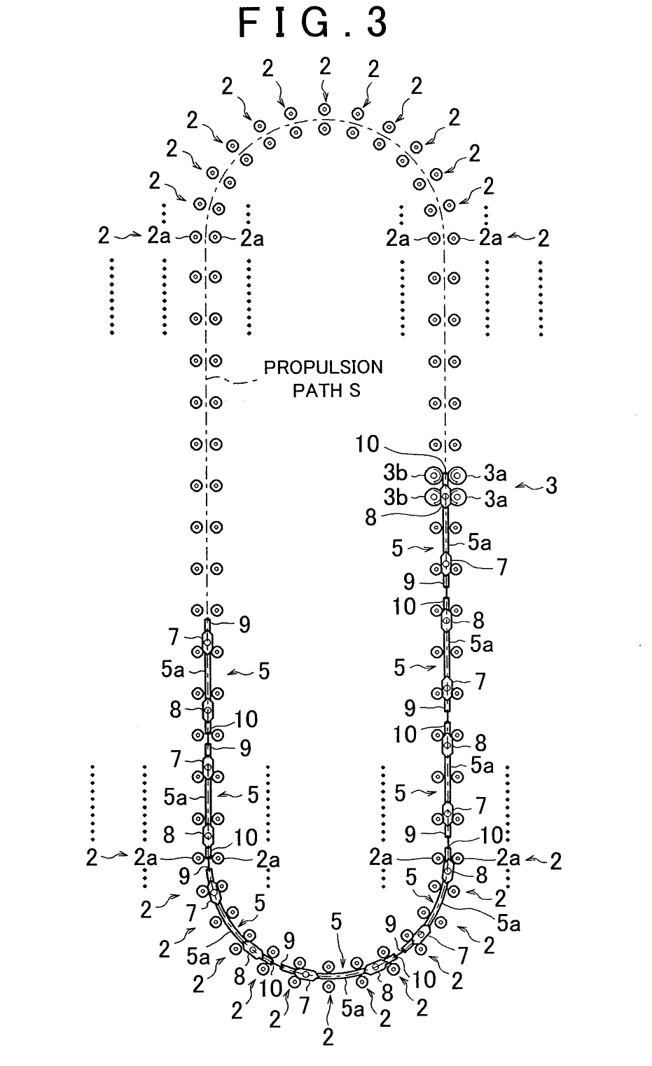

As shown in FIGS. 1 and 3, in the truck-type conveyance system 1, the plurality of guides 2 are placed along a desired path. A propulsion path S along which the propelled portions 5 are propelled is thereby formed. More specifically, the guides 2 are placed such that the propulsive direction set in the horizontal guide rollers 2a corresponds to the desired path in a linear path. On the other hand, in a curved path, the guides 2 are placed such that the propulsive direction corresponds to the tangential direction of a desired path.

Further, in the truck-type conveyance system 1, the placement number and placement spacing of the guides 2 in the propulsion path S are appropriately set. Accordingly, the single propelled portion 5 is consistently guided by at least three guides 2.

Further, the propulsion path S described in this embodiment has shorter placement spacing among the guides 2 in curved sections compared to linear sections of the propulsion path S. This allows more stable propulsion of the propelled portions 5 by guides 2 in the curved propulsion path S. That is, in the truck-type conveyance system 1, the placement spacing among the guides 2 may be made shorter when the radii of curvature of the curved sections in the propulsion path S are smaller.

In this embodiment, the plurality of guides 2 are placed in a generally oval shape in a plan view so that the propulsion path S is a continuous (i.e., endless) circumferential path. Embodiments of the propulsion path S in the truck-type conveyance system in accordance with the present invention are not limited to this, but may be formed with a starting end and a terminal end or generally rectangular or formed with a circumferential path in the shape of a rectangle or an oval in general.

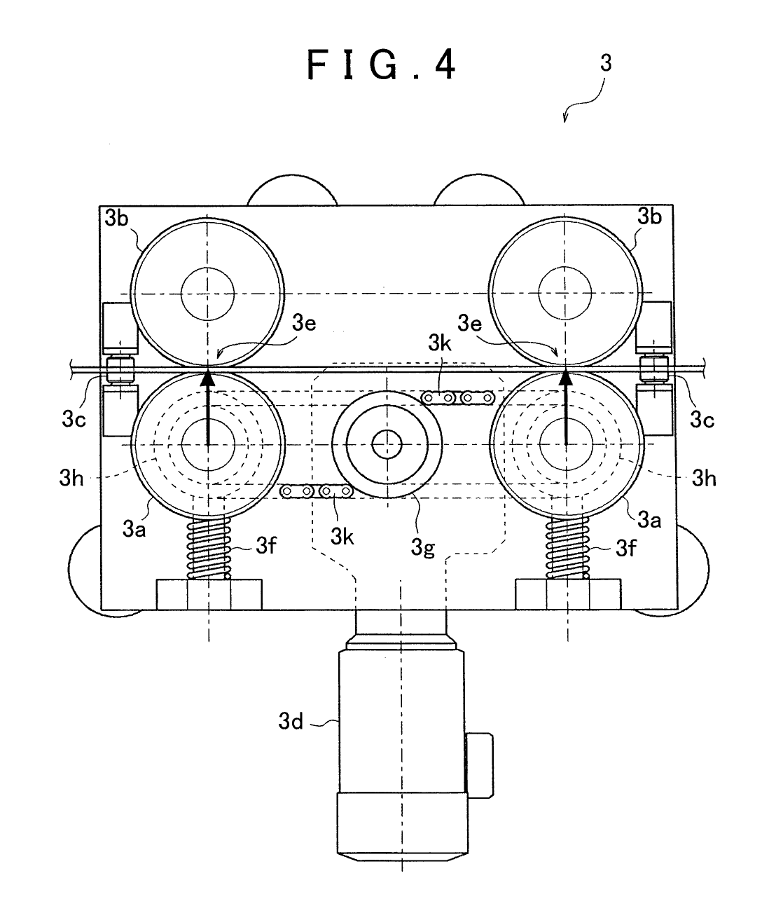

As shown in FIG. 1, the truck-type conveyance system 1 has the drive unit 3 for providing force for propelling (propulsive force) the propelled portions 5 in the propulsive direction. The drive unit 3 is placed on the propulsion path S formed with the plurality of guides 2. As shown in FIG. 4, the drive unit 3 has rotationally driven drive rollers 3a, driven rollers 3b that are placed to face the drive rollers 3a and contact with the drive rollers 3a, driven rollers 3c that contact with a lower portion of the driven member 5a introduced into the drive rollers 3a and the driven rollers 3b and serve similarly to the vertical guide roller 2b in the above-described guide 2, a drive motor 3d for rotationally driving the drive rollers 3a, and so forth. The drive unit 3 forms squeezing portions 3e for squeezing the propelled portion 5 in the section in which the drive rollers 3a and the respective driven rollers 3b contact with each other. The squeezing portions 3e are placed on the propulsion path S.

In the drive unit 3, the pair of drive roller 3a and the driven roller 3b are journaled in parallel with each other while keeping their axial directions vertical. A spring member 3f urges the drive roller 3a toward the driven roller 3b, and the drive roller 3a is pushed toward the driven roller 3b. Accordingly, the squeezing portion 3e in which the rollers 3a, 3b can squeeze the propelled portion 5 is formed. The drive roller 3a is rotationally driven in a condition that the propelled portion 5 is squeezed in the squeezing portion 3e. Frictional force is provided to the propelled portion 5 in the propulsive direction of the propelled portion 5 that is the tangential direction of each of the rollers 3a, 3b in the squeezing portion 3e. The drive unit 3 described in this embodiment has the two pairs of drive rollers 3a and driven rollers 3b.

In the drive roller 3a, a section (i.e., a peripheral surface of the drive roller 3a) in the squeezing portion 3e which contacts with the propelled portion 5 is covered by a material with a large friction coefficient such as rubber. The drive roller 3a can efficiently provide frictional force to the propelled portion 5 in the squeezing portion 3e. A gear motor or the like can be used as the drive motor 3d of the drive unit 3.

A sprocket 3g is fixed around the rotation axis of the drive motor 3d. Since the drive unit 3 described in this embodiment has the two drive rollers 3a, the two sprockets 3g are provided in positions offset in the rotation axis direction. Sprockets 3h are fixed around the rotation axes of the respective drive rollers 3a. A drive chain 3k is wound around the sprockets 3g, 3h. Accordingly, driving force generated by the drive motor 3d is transmitted to the drive rollers 3a via the drive chains 3k.

Further, in the squeezing portion 3e, the propelled portion 5 is squeezed, and at the same time each of the drive rollers 3a is rotated by the drive motor 3d, thereby generating frictional force between the rollers 3a, 3b and the propelled portion 5. Accordingly, each of the propelled portions 5 is provided with propulsive force in the direction along the propulsion path S.

As shown in FIGS. 1, 2, and 5, the work floor 4 is positioned above the guides 2 and the drive unit 3, forms the floor surface on which the trucks 6 travel, forms the working space for workers during attachment of each kind of parts to a workpiece 11 placed on the truck 6, and is formed with a floor member 4a, support members 4b, and so forth. In the floor member 4a, a through groove 4c passing though the floor member 4a along the propulsion path S is formed.

In the work floor 4, the floor surface is formed by placing the floor member 4a in a double flooring manner at a higher level (level FL shown in FIG. 2) than the floor level (level GL shown in FIG. 2) of the workspace. A space between level GL and level FL is used to house the guides 2, the drive unit 3, and so forth. Accordingly, in the truck-type conveyance system 1, a space for placing the drive unit 3 and so forth does not have to be secured by reducing the workspace.

In this embodiment, the floor surface of the work floor 4 is at the higher level than level GL. However, in an embodiment in which a level (so-called trough) further lower than the floor level (level GL) of the work space is provided, the floor surface of the work floor 4 may be provided at the same level as level GL, and the guides 2, the drive unit 3, and so forth may be thereby housed in the trough.

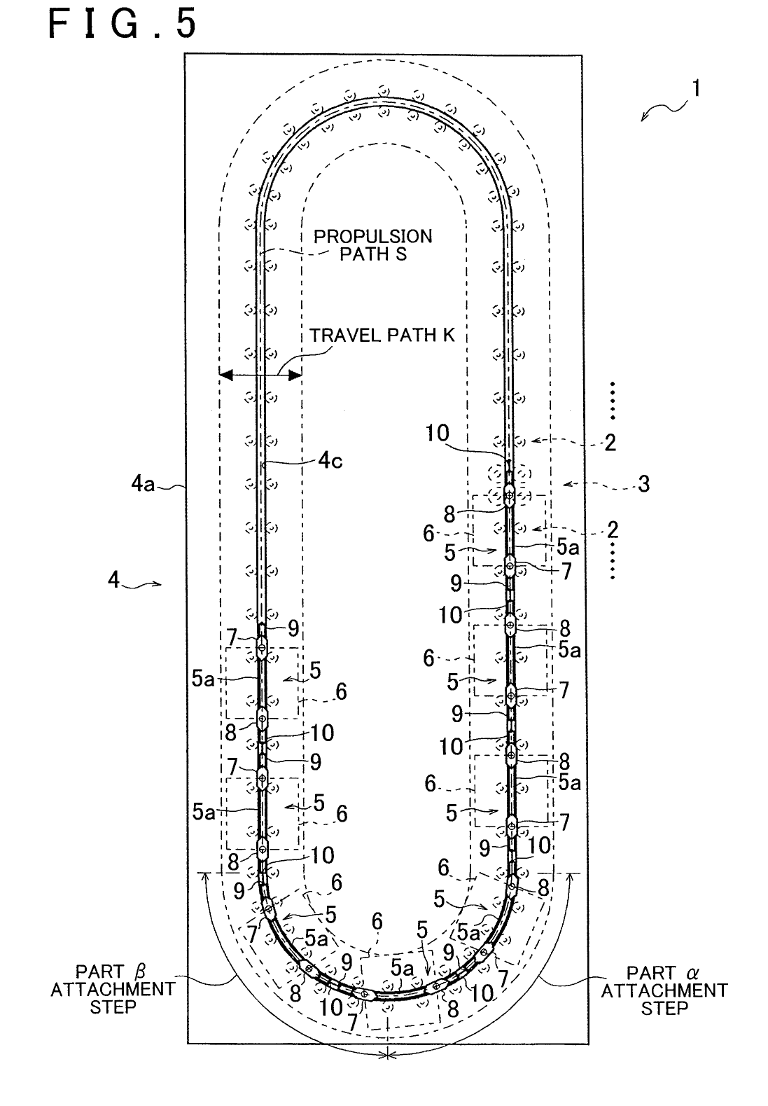

The truck-type conveyance system 1 in accordance with this embodiment allows the truck 6 to travel along the curved propulsion path S on the work floor 4. Therefore, as shown in FIG. 5, work steps (for example, a part a attachment step and a part 13 attachment step shown in FIG. 5) can be placed in a curved section of a travel path K of the truck 6. Accordingly, the work steps can be placed with respect to a workpiece conveyance path by a more flexible arrangement than a conventional system. Further, the workspace that can be effectively used can be increased.

That is, in the Mick-type conveyance system 1 in accordance with an embodiment of the present invention, the drive unit 3 is placed on the side (a portion beneath the floor of the floor member 4 in this embodiment) vertically opposite to the side on which the truck 6 is placed across the floor member 4a on which the truck 6 travels. Such a configuration allows more effective use of the workspace.

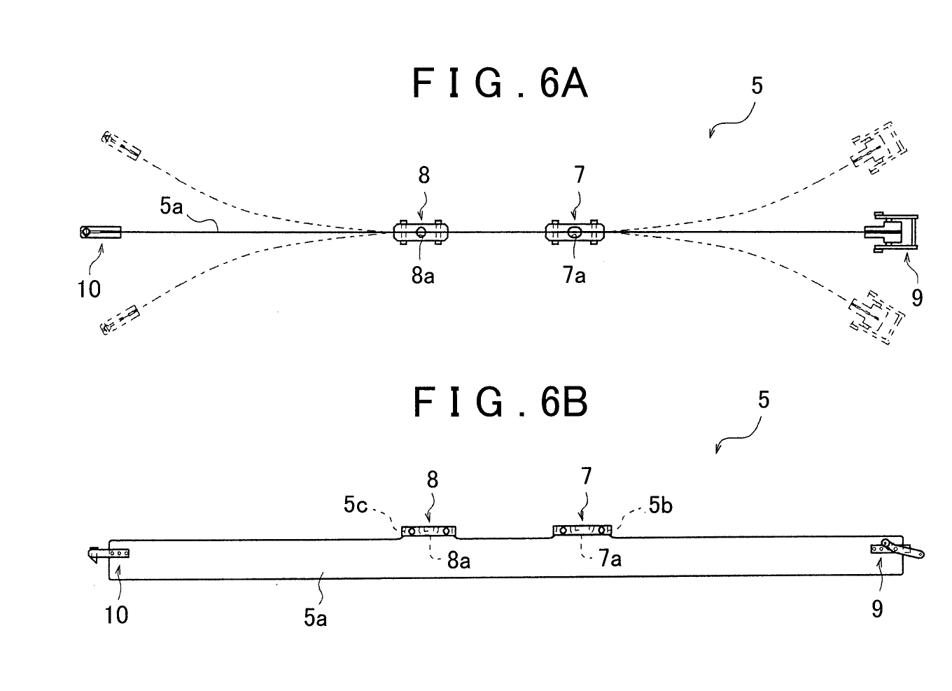

As shown in FIGS. 1 and 6, the propelled portion 5 is propelled along the propulsion path S formed with the plurality of guides 2 by frictional force provided by the drive unit 3 as its propulsive force, and is configured with the driven member 5a, locking member 7, 8, a first coupling portion 9, a second coupling portion 10, and so forth.

As shown in FIGS. 6, the driven member 5a constructing a main portion of the propelled portion 5 has its longitudinal direction along the direction of the propulsion path S and formed of a belt-like steel plate and has a property of being deformable in its thickness direction when external force is applied and recovering to its original general plate shape when it is released from the external force.

The driven member 5a is formed into the belt-like shape as described above. Accordingly, for example, the driven member 5a can be more easily bent in the horizontal direction than a generally rod-shaped driven member, and the driven member 5a can be easily recovered to its original plate shape. Therefore, the belt-like shape is appropriate for the driven member 5a in the case that the driven member 5a is elastically deformed. In this embodiment, the driven member 5a in the truck-type conveyance system 1 is in the belt-like shape. However, it is not necessarily required that the shape of the driven member 5a be the belt-like shape, but an elastic member in another shape (for example, rod shape or the like) can be used.

Kinds of materials used for the driven member 5a may be, for example, steel plates such as hardened steel bands. In a case that the propulsion path S has curves in its shape, hardened steel bands can be easily elastically deformed along the curvatures. Further, in a case that the propulsion path S is linear in its shape, those can be easily and accurately recovered to plate shapes. In this embodiment, the material for the driven member 5a is a hardened steel band, various elastically deformable materials may be used for forming the driven member 5a.

In other words, the truck-type conveyance system 1 in accordance with an embodiment of the present invention is configured with the propelled portion 5 having the belt-like driven member 5a. Such a configuration enables easy deformation of the propelled portion 5 along the propulsion path S.

The truck-type conveyance system 1 in accordance with an embodiment of the present invention is configured with the belt-like driven member 5a that is formed with a steel plate such as a hardened steel band. Such a configuration allows easy deformation of the propelled portion 5 along the curved propulsion path S and allows easy recovery of the propelled portion 5 to the plate shape along the linear propulsion path S.

On an upper side (i.e., the opposite side of the side with which the vertical guide roller 2b contacts) of the driven member 5a, the support portions 5b, 5c protruding upward are formed. The locking members 7, 8 for locking the truck 6 are attached along the support potions 5b, 5c. In a state in which the propelled portion 5 (the driven member 5a) is guided by the guides 2, the support portions 5b, 5c are formed to protrude from the through groove 4c above the floor surface and support the locking members 7, 8 above the travel surface (the floor surface) of the truck 6 on the work floor 4. The locking members 7, 8 have locking holes 7a, 8a formed therein for locking respective locking portions 6c, 6d of the truck 6, which will be described later.

The first coupling portion 9 is attached to a front end of the driven member 5a with respect to the propulsive direction. The second coupling portion 10 is attached to a rear end of the driven member 5a with respect to the propulsive direction. The first coupling portion 9 and the second coupling portion 10 are capable of coupling or decoupling the propelled portions 5.

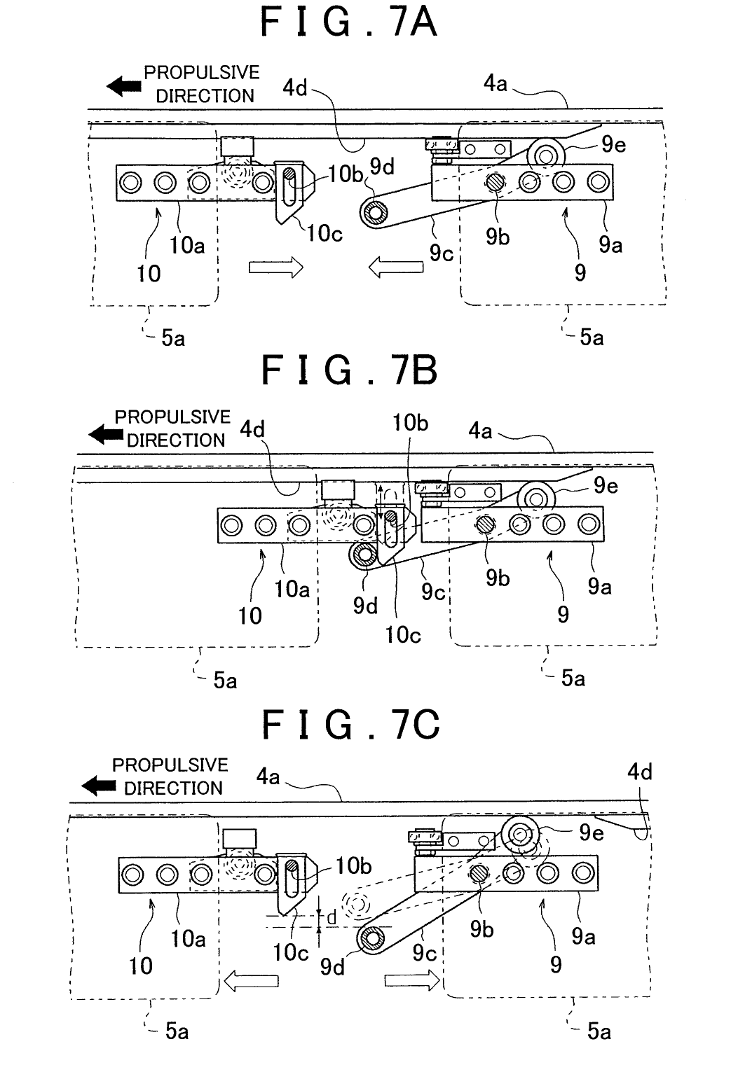

As shown in FIG. 7A, the first coupling portion 9 is fixed to the front end of the driven member 5a by a main portion 9a. The first coupling portion 9 has a shaft portion 9b in the main portion 9a and a link member 9c vertically swingably supported by the shaft portion 9b. Further, the link member 9c has a locking portion 9d at its front end and a roller member 9e at its rear end.

The second coupling portion 10 is fixed to a rear end of the driven member 5a by a main portion 10a. The second coupling portion 10 has a shaft portion 10b in the main portion 10a and a locking member 10c vertically shiftably supported by the shaft portion 10b. The dimensions of the coupling portions 9 and 10 in their width directions are sufficiently large compared to the width of the through groove 4c formed in the floor member 4a. Therefore, the driven member 5a is surely prevented from moving upward during propulsion of the propelled portion 5.

In the truck-type conveyance system 1, liner members 4d protruding downward are appropriately provided on a lower surface of the floor member 4a. The liner member 4d is placed in a position that allows contact with the roller member 9e of the first coupling portion 9. In the section where the liner member 4d is present, the roller member 9e is pushed downward by the liner member 4d, and the link member 9c is swung such that the locking portion 9d is pushed upward.

When the first coupling member 9 is brought into contact with the second coupling member 10 in such a state, as shown in FIGS. 7, the locking portion 9d is first pushed to an inclined surface formed in a lower rear portion of the locking member 10c, and the locking member 10c is thereby pushed upward by the locking portion 9d. Thereafter, the locking portion 9d is pushed to a position in front of the locking member 10c, and as a result the locking member 10c is depressed downward. Accordingly, the locking portion 9d and the locking member 10c are locked together. The coupling portions 9 and 10 are thereby coupled together. In other words, the front and rear propelled portions 5 are coupled together by coupling portions 9, 10. This state is retained as long as the liner member 4d is continuously present.

The plurality of serial propelled portions 5 on the propulsion path S can be unitarily coupled by coupling the first coupling portion 9 and the second coupling portion 10 of each of the pails of front and rear propelled portions 5. The plurality of propelled portions 5 that are unitarily coupled in such a manner can be unitarily propelled by propulsive force provided from the drive unit 3 to any one of the propelled portions 5. For example, as shown in FIGS. 3 and 5, in a case that the seven propelled portions 5 are unitarily coupled by the coupling portions 9, 10, any one of the propelled portions 5 is provided with propulsive force by the drive unit 3, and the coupled seven propelled portions 5 are thereby unitarily propelled.

On the other hand, in the sections in which no liner member 4d is present on the lower surface of the floor member 4a, no liner member 4d pushes the roller member 9e, and the link member 9c is swung such that the locking portion 9d is kept depressed to the lower end.

As shown in FIG. 7C, in such a state, since a lower end of the locking member 10c and an upper end of the locking portion 9d are separated in distance d, the locking portion 9b and the locking member 10c cannot lock each other. Accordingly, the coupling portions 9, 10 are decoupled. In other words, since the front and rear propelled portions 5 are not coupled by the coupling portions 9, 10 in the section in which no liner member 4d is present, when the propelled portions 5 are continuously positioned with no gap, the trucks 6 can be travelled by propulsive force provided by the drive unit 3. In addition, the truck 6 is propelled by the force applied by a worker, and the propelled portions 5 can be thereby separately propelled in the state in which they are separated from propulsive force from the drive unit 3.

As described above, in the truck-type conveyance system 1, since the manner of how the plurality of the propelled portions 5 are propelled can be switched between unitary and separate propulsion in response to the setting of a certain work step section. The switch can be easily made by the setting whether the liner member 4d is provided or no liner member 4d is provided. This allows more flexible adaptation to changes in the work step arrangement or the like.

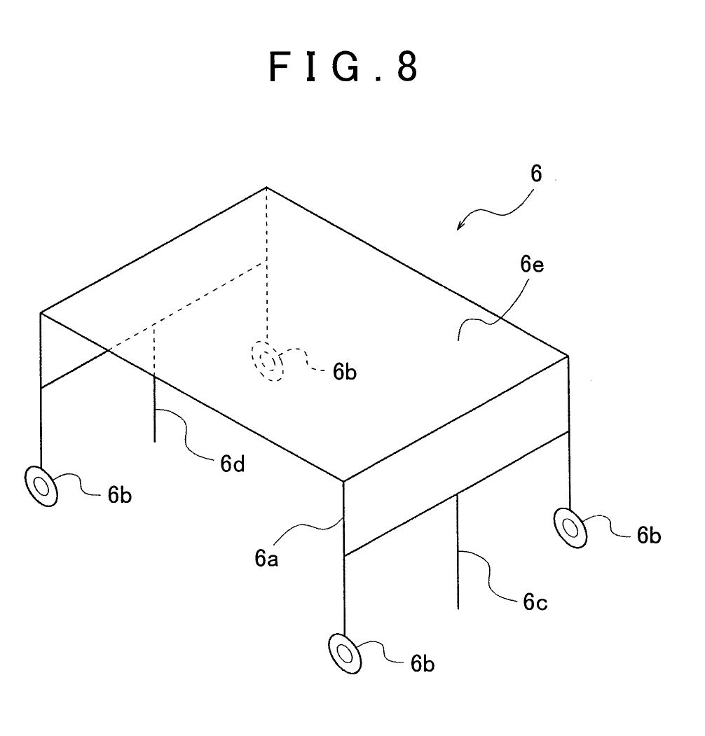

As shown in FIGS. 1 and 8, the truck 6 is locked on the propelled portion 5 and travels on the travel surface in response to the propulsive force provided to the propelled portion 5, and has a main body 6a, traveling wheels 6b locking portions 6c, 6d, and so forth. A placement surface 6e that is a flat surface for placing the workpiece 11 is formed on an upper surface of the main body 6a.

The traveling wheels 6b are attached to legs of the main body 6a such that the axes of the traveling wheels 6b are rotatable on a horizontal plane. The traveling direction of the truck 6 can be thereby freely changed.

The locking portions 6c, 6d protrude downward from the main body 6a. In the state in which the truck 6 is placed on the travel surface on the floor member 4a, lower ends of the locking portions 6c, 6d are at a level lower than upper surfaces of the locking members 7, 8 and higher than the floor surface of the floor member 4a.

In the truck-type conveyance system 1, the truck 6 and the propelled portion 5 make a pair. The locking portions 6c, 6d of the truck 6 are locked by the locking members 7, 8 attached to the propelled portion 5. As described above, the truck 6 is supported at two points and can thereby travel while keeping a position generally in parallel with the propulsion path S.

In this embodiment, the inner diameter of the locking hole 7a corresponds to the outer diameter of the locking portion 6c, through which the locking portion 6c can pass. Similarly, the inner diameter of the locking hole 8a corresponds to the outer diameter of the locking portion 6d, through which the locking portion 6d can pass. When the driven member 5a is bent along the propulsion path S in the curved section of the propulsion path S, the separation distance between the locking holes 7a and 8a changes. Therefore, to absorb such displacement, at least one of the locking holes 7a, 8a has a larger diameter having a slight allowance compared to the outer diameter of the locking portion 6d.

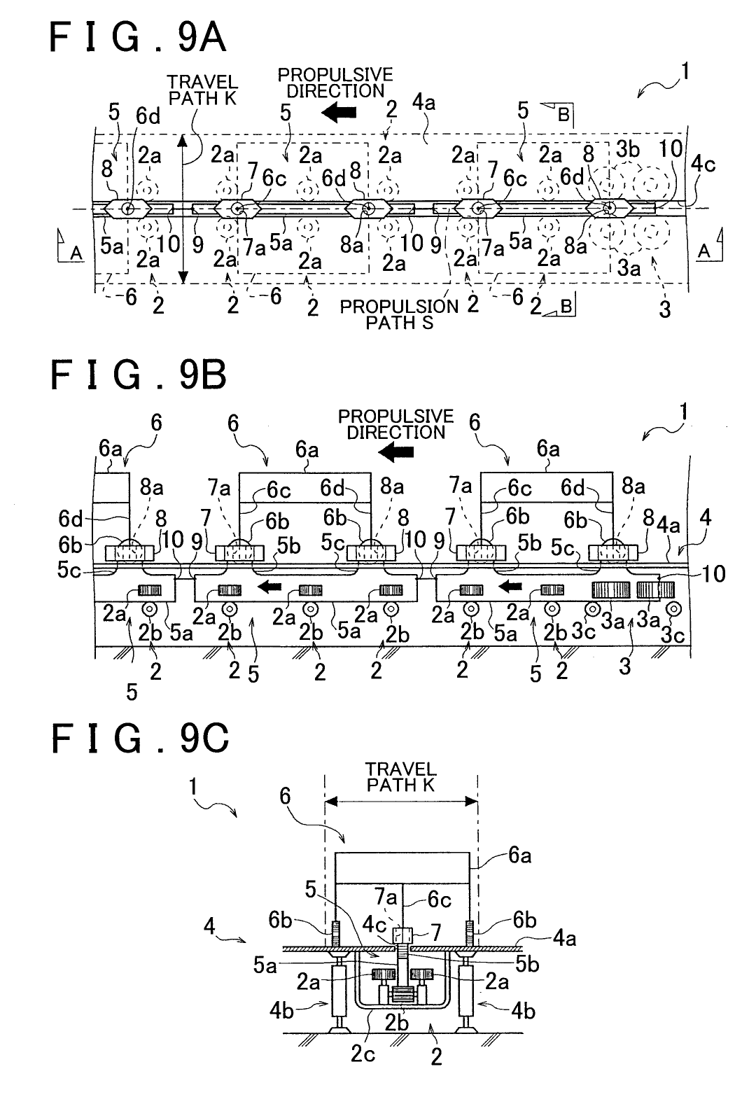

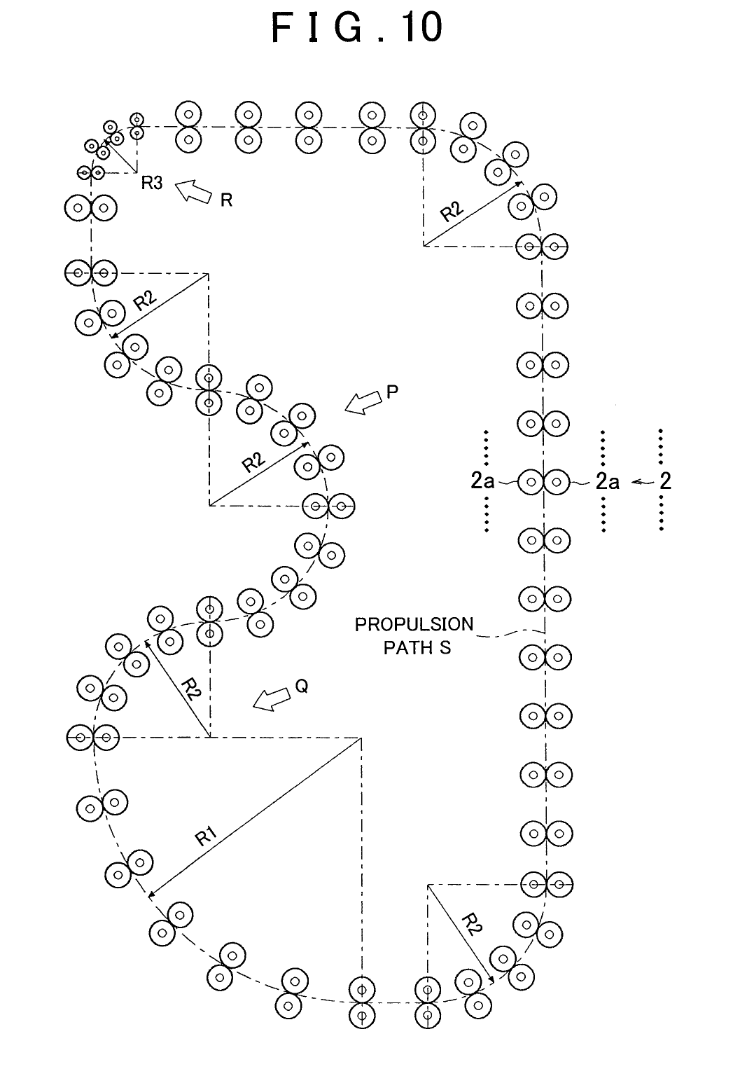

Next the traveling condition of the truck 6 in the truck-type conveyance system 1 in accordance with an embodiment of the present invention will be described with reference to FIGS. 9 and 10. As shown in FIG. 9A, in the truck-type conveyance system 1 in accordance with an embodiment of the present invention, the propelled portions 5 are propelled along the propulsion path S formed with guides 2. The front and rear propelled portions 5 are coupled together by the coupling portions 9, 10, and the propelled portions 5 are thereby unitarily propelled. The locking members 7, 8 are attached to the propelled portion 5. Accordingly, the propelled portion 5 is propelled along the propulsion path S, and portions above the work floor 4 is propelled along the propulsion path S together with the locking members 7, 8.

The truck 6 has the locking portions 6c, 6d corresponding to the locking members 7, 8. The locking portions 6c, 6d are inserted into the locking holes 7a, 8a formed in the locking members 7, 8, and the truck 6 can be locked by the locking members 7, 8. While the locking members 7, 8 are propelled along the propulsion path S on the work floor 4, the trucks 6 can travel along the travel path K on the work floor 4 along the propulsion path S with the generally constant intervals among the trucks 6 being kept.

At this point, since the driven member 5a of the propelled portion 5 is flexible in the plate thickness direction (see FIG. 6A) and is elastically deformable, the driven member 5a itself can be bent in response to curve conditions of the propulsion path S. Accordingly, as shown in FIG. 10, the truck-type conveyance system 1 can easily adapt to propulsion paths with changes in the placement positions of the guides 2, their placement number, their placement spacing, and so forth and with no change in the configuration of propelled portion 5, for example, even in cases that a propulsion path P (the section shown by arrow P in FIG. 10) has a plurality of serial curves, that a propulsion path Q (the section shown by arrow Q in FIG. 10) has serial curved sections having different radii of curvatures R1, R2, and that a propulsion path R (the section shown by arrow R in FIG. 10) has a curved section having a radius of curvature R3 smaller than the radii of curvatures R1, R2. Therefore, the truck-type conveyance system 1 can more flexibly adapt to desired work step arrangements.

In the truck-type conveyance system 1, only the locking members 7, 8 and the truck 6 are exposed above the floor member 4a. The locking members 7, 8 can be covered by a lower portion of the truck 6. Further, the through groove 4c formed in the floor member 4a can be formed into a very narrow gap which is slightly wider than the thickness of the driven member 5a. Accordingly, with the truck-type conveyance system 1, a flat workspace with high work efficiency can be realized.

Accordingly, the truck-type conveyance system 1 in accordance with an embodiment of the present invention includes the propelled portion 5 which is propelled with frictional force, the truck 6 which is coupled with the propelled portion 5, the guides 2 that are the plurality of guide members which are defining the propulsive direction of the propelled portion 5 and forming the propulsion path S, and the drive unit 3 which provides frictional force in the propulsive direction to the propelled portion 5. In the system, the truck 6 travels along the propulsion path S with frictional force provided to the propelled portion 5 as its propulsive force. Further, the propelled portion 5 is formed with the driven member 5a which is an elastic member elastically deforming along the curvature of the propulsion path S. With such a configuration, even if the travel path K of the truck 6 is curved, the truck 6 can travel along the travel path K without use of a separate conveyance system.

In the truck-type conveyance system 1 in accordance with an embodiment of the present invention, the through groove 4c which passes through the travel surface (the floor surface of the floor member 4a) of the truck 6 is formed along the propulsion routes. The support portions 5b, 5c which protrude from the driven member 5a are arranged on the truck-placement side (i.e., on the floor surface of the floor member 4a in this embodiment) from the through groove 4c across the travel surface (the floor member 4a) of the truck 6. The locking members 7, 8 are disposed on the support portions 5b, 5c. The truck 6 is locked by the locking members 7, 8. The driven member 5a and the truck 6 are thereby coupled together. With such a simple configuration, even if the travel path K of the truck 6 is curved, the truck 6 can travel along the travel path K without use of a separate conveyance system.

1. A truck-type conveyance system comprising:
a propelled portion which is propelled with frictional force;
a truck which is coupled with the propelled portion;
a plurality of guide members which define a propulsive direction of the propelled portion and form a propulsion path; and
a drive unit which provides frictional force in the propulsive direction to the propelled portion,
wherein the truck travels along the propulsion path with frictional force provided to the propelled portion as propulsive force thereof, and
a section of the propelled portion to which the frictional force is provided is formed with an elastic member which is a member elastically deforming along the propulsion path.

2. The truck-type conveyance system according to claim 1, wherein the elastic member is a belt-like member.

3. The truck-type conveyance system according to claim 1 or 2, wherein the elastic member is formed with a steel plate.

4. The truck-type conveyance system according to any one of claims 1 to 3, wherein the drive unit is placed below a travel surface on which the truck travels.

5. The truck-type conveyance system according to claim 4, wherein a groove which is passed through the travel surface of the truck is formed along the propulsion path, a support portion which protrudes from the elastic member is arranged on a truck-placement side from the groove across the travel surface of the truck, a locking member is disposed on the support portion, the truck is locked by the locking member, and the elastic member and the truck are thereby coupled together.

6. The truck conveyance system according to any one of claims 1 to 3, wherein the travel surface of the truck is placed at a level different from a level at which the guide members and the drive unit are placed.
